(19) United States
(12) Patent Application Publication
(10) Pub. No.: US 2004/0265422 A1
(43) Pub. Date: Dec. 30, 2004

(54) Apparatus and method for fluid distribution

(75) Inventors: Douglas Sabin, Marblehead, MA (US); Paul Swenson, South Hamilton, MA (US)

Correspondence Address: LAHIVE & COCKFIELD, LLP., 28 STATE STREET, BOSTON, MA, 02109, US

(73) Assignee: KORTEC, INC., Beverly, MA

(21) Appl. No.: 10/851,610

(22) Filed: May 20, 2004

Related U.S. Application Data
(60) Provisional application No. 60/472,179, filed on May 20, 2003.

(51) Int. Cl. B29C 45/16

(52) U.S. Cl. 425/572; 425/533; 425/573; 425/130

(57) ABSTRACT

A method and apparatus for evenly distributing a fluid that exhibits shear heating is disclosed herein. The method and apparatus provide an intersection geometry for an intersection of a bore and sub-bore. The intersection geometry controls distribution of a flow asymmetry of a working material to facilitate the division of shear heated material into substantially equal portions at subsequent downstream locations. At least one method is disclosed for forming the flow bore intersections of the present invention.

### RELATED APPLICATIONS

This application claims the benefit of U.S. Provisional Patent Application No. 60/472,179 filed May 20, 2003, and entitled Apparatus And Method For Fluid Distribution.

### BACKGROUND OF INVENTION

The present invention generally relates to an apparatus and method for distributing a fluid, and more particularly relates to an apparatus and method for distributing a fluid, such as a molten polymer, that exhibits shear heating.

In the art of fabricating goods from molten polymers, hot runners distribute the molten polymers from a set of inlets to a set of outlets. Usually there are more outlets than inlets so a manifold structure is employed where the flow bores split or combine one or more times to carry the molten polymers into a multiplicity of sub bores to distribute the molten polymers from the set of inlets to the set of outlets.

A hot runner may comprise a manifold whose outlets connect to nozzles. A hot runner may also comprise several manifold blocks where polymer flows from manifold to manifold and eventually to a set of nozzles that fill one or more cavities. One or more nozzles may fill each cavity.

In the case of co-injection a hot runner system may contain more than one material. Often two materials are conveyed from two inlets to two sets of outlets. Each nozzle is fed by one outlet from each material.

It is often desirable to create an equal pressure drop and heat history in every path from an inlet to an outlet. This symmetry allows for easier processing by creating a larger process window. When this condition is not met, certain cavities fill prematurely while others fill late, making molding more difficult and lowering the quality of the resultant goods.

In co-injection systems that simultaneously inject more than one polymer, it is beneficial to have an equal pressure drop and heat history in the flow path through the hot runner to each cavity. The reason for this is that a volumetric flow rate of any material at any time should be substantially similar in each cavity.

Conventionally, this is achieved by creating naturally balanced systems. A naturally balanced system has a geometry that allows every path from an inlet to an outlet to pass though identically sized flow bores. Each flow bore segment will have the same length and diameter. Generally as the flow splits from an inlet into sub bores the bore diameter of each successive sub-bore is reduced to properly accommodate the quantity of material flowing. While this geometry helps eliminate asymmetries in the flow, some are still created by shear heating affects.

When a polymer material is sheared, a significant amount of heat is created. The center of the flow is characterized as a high velocity-low shear flow and consequently the cooler portion of the flow. In contrast, the edges of the flow are characterized as a low velocity-high shear flow and consequently the hotter portion of the flow. When a flow split occurs at a conventional “T” like geometry of a hot runner where the main leg of the “T” feeds two smaller sub bores, the outer hot material from the main leg is divided equally between the sub bores, but its distribution in the sub bores is not uniform. That is, the hot material remains closest to the main leg of the “T” and the cold material, which flows through the center portion of the main leg, flows away from the main leg feeding the “T”. If the next or second flow split in the hot runner has a “T” like geometry all the hot material from the sub-bore feeding the first “T” like flow split flows down one leg of the second flow split and the cold material flows down the other leg. Which leg of the second flow split the hot and cold material flow into depends on orientation of the sub-bores of the second flow split relative to the hot and cold material flowing into the second flow split. Unfortunately, this condition creates flow asymmetries since the hot material is less viscous than the cold material, and hence flows more quickly. A significant drawback of this correlation is that it creates overall processing problems, while concomitantly the quality of the resultant products.

### SUMMARY OF INVENTION

The present invention addresses the above-described limitations of distributing a fluid that exhibits shear heating. The present invention provides an approach to equalize distribution of a flow bulk temperature of shear heated material in a distribution mechanism. To equalize distribution of the flow bulk temperature of the shear heated material, an intersection geometry of non-intersecting axes is disclosed. A significant result of this intersection geometry where the central longitudinal axis of at least two of the flow channels forming the intersection avoid formation of a common point (i.e., non-intersecting axes) in the intersection is the division of the shear heated material into substantially equal portions for each downstream channel of the intersection.

In one illustrative embodiment of the present invention, a distribution means for distributing a molten working material from a working material source to a processing means having at least one input to receive the molten working material is provided. The distribution means includes a number of distribution elements. Each of the distribution elements includes an inner passage to transport the molten working material from a proximal portion to a distal portion of each distribution element. Each of the inner passages has a circular cross-section and a longitudinal axis located at a central inner portion of each distribution element.

The distribution elements intersect with one another at respective end portions to form a network of distribution elements in the distribution means for distributing the molten working material from the working material source to the inputs of the processing means. In at least one intersection where the distribution elements intersect, the central longitudinal axis of at least one of the distribution elements does not intersect the central longitudinal axis of one or more of the remaining distribution elements that forms a portion of the network intersection. Consequently, at least two of the central longitudinal axes of the distribution elements forming the intersection are skewed.

As used herein, the term “skewed” refers to straight lines that do not intersect and are not in the same plane.

The ability to create an intersection where selected distribution elements intersect so that the central longitudinal axis of one or more of the distribution elements is skewed from the others to avoid intersecting central longitudinal axes enables the distribution elements feed a number of nozzle assemblies with a number of working material flows that have a substantially similar flow rate and a substantially similar thermal property, such as a shear-heating thermal property.

In another aspect of the present invention, an apparatus is provided having an input and a number of outputs for distribution of a working material having a thermal property. The apparatus receives the working material at the input and distributes the working material to each of the outputs in a manner that allows the working material to flow out from each of the outputs in multiple streams that have a like-flow rate with a substantially like-thermal property, such as a shear-heating thermal property.

The apparatus includes a network of distribution elements. The network communicates with the input of the apparatus and each of the outputs to distribute the working material received at the input to each of the outputs. Each distribution element of the network includes an inner passage for transmitting the working material from a first-end portion to a second-end portion along a central axis of the distribution element. The distribution elements interconnect with each other at a respective end portion so that a central longitudinal axis of at least two distribution elements is skewed relative to each other.

The network of distribution elements is capable of including a first set of distribution elements and a second set of distribution elements. The distribution elements belonging to the first set have a like-inner passage dimension and a like-length dimension. In similar fashion, each of the distribution elements belonging to the second set has a like-inner passage dimension and a like-length dimension. To assist in providing each of the outputs with a stream of working material having a like-flow rate, the like-inner passage dimensions of the distribution elements belonging to the second set have a value less than a dimension value of the like-inner passage dimensions of the distribution elements belonging to the first set. The first set of distribution elements couple with the second set of distribution elements at selected locations in the apparatus to form the network of distribution elements. At each intersection of a distribution element from the first set and a distribution element from the second set the respective end portions of each distribution element form an intersection geometry where the central axis of each distribution element fails to intersect. Those skilled in the art will appreciate that the discussion of two sets of distribution elements is meant to facilitate explanation of the invention and is not meant to limit the number of sets of distribution elements the network of distribution elements can include.

Manufacturing of a distribution network, such as a hot runner in accordance with one aspect of the present invention, is accomplished by forming or machining, for example gun drilling and finishing with a ball end drill, the flow bore passages at an angle offset from an orthogonal of a face of the hot runner. Formation of the flow bores or distribution elements at an angle offset from the orthogonal of a face of a work piece, such as a block of suitable metallic material. Suitable metallic materials include, but are not limited to stainless steel, manganese, or other metallic composition. The formation of the flow bores in this manner allows the flow bore passages to intersect at an intersection within the distribution means without having a longitudinal axis centrally located within a circular inner passage of each flow bore passage intersect.

Consequently, the formation of the flow bores or distribution elements in this manner allows the distribution means to apportion a thermal property of a molten working material into substantially equal portions along each of the flow bores, or distribution elements from an input to an output of the distribution means to form a number of working material streams having a number of like material properties. That is, each of the flow bore passages of the distribution means can have a substantially straight inner flow passage and the distribution means can apportion a thermal property of a molten working material into substantially equal portions along each of the flow bores, or distribution elements from an input to an output of the distribution means to form a number of working material streams having a number of like material properties.

In another embodiment of the present invention, a distribution network for distributing a molten working material from a working material source to a mold having at least one input to receive the molten working material is disclosed. The distribution network includes a first flow channel having an inner passage and a central longitudinal axis and a second flow channel having an inner passage and a central longitudinal axis. A portion of first flow channel and a portion of the second flow channel intersect at a location in the distribution means to form an intersection. In the intersection formed by the first and second flow channels, the central longitudinal axis of the first flow channel and the central longitudinal axis of the second flow channel are non-intersecting. The non-intersecting central longitudinal axes of the first and second flow channels in the intersection allows the balancing of a thermal property of the working material flowing from the first flow channel into the intersection between subsequent working material flows carried by the second flow channel.

In one aspect of the present invention the first flow channel and the second flow channel orthogonally intersect at offset planes. In this manner, the working material flowing from the first flow channel into the intersection is distributed between and positioned within the second flow channel to facilitate a further splitting and distribution at an intersection downstream.

### BRIEF DESCRIPTION OF DRAWINGS

The foregoing and other objects, features and advantages of the invention will be apparent from the following description and apparent from the accompanying drawings, in which like reference characters refer to the same parts throughout the different views. The drawings illustrate principles of the invention and, although not to scale, show relative dimensions.

FIG. 1A depicts a top view of a prior art two way split in a hot runner.

FIG. 1B depicts an isometric view of the prior art two-way split illustrated in FIG. 1A.

FIG. 1C depicts a prior art hot runner having two “T” like splits.

FIG. 2 is an exemplary flow division map of the prior art two way split illustrated in FIGS. 1A and 1B.

FIG. 3A depicts an exemplary top view of an exemplary two-way split in a hot runner in accordance with one aspect of the present invention.

FIG. 3B depicts an exemplary isometric view of the-two-way split illustrated in FIG. 3A.

FIG. 4 is an exemplary flow map of the exemplary two-way split illustrated in FIGS. 3A and 3B.

FIG. 5 depicts another exemplary two-way split of a hot runner in accordance with the present invention.

FIG. 6 depicts an exemplary flow map of the two-way split illustrated in FIG. 5.

FIG. 7A depicts a prior art exemplary four way split in accordance with the present invention.

FIG. 7B depicts an exemplary flow map illustrating distribution of shear heated material in a portion of the four way split depicted in FIG. 7B.

FIG. 7C depicts a prior art four way split in a hot runner assembly.

FIG. 7D depicts an exemplary flow map illustrating distribution of shear heated material in a portion of the four way split depicted in FIG. 7C.

FIG. 8 depicts a block diagram of an exemplary co-injection system suitable for practicing the present invention.

FIG. 9 depicts a block diagram of an exemplary injection system suitable for practicing the present invention.

### DETAILED DESCRIPTION

The present invention is directed to a distribution mechanism, such as a hot runner, having a bore intersection geometry sufficient to equalize distribution of a thermal property, such as flow bulk temperature to sub bores from a main bore. This is accomplished by an improved geometry at locations of the distribution mechanism where two or more bores intersect or split. The present invention improves the geometry of the distribution mechanism at a location where two or more bores intersect by employing a plurality of bores having non-intersecting longitudinal bore axes. This arrangement improves, reduces or eliminates any potential thermal asymmetries created in the flow by preceding the flow splits. Moreover, the flow bore geometry of the present invention improves the division of shear heated material at the initial split in a hot runner by aligning the material in a desired fashion to facilitate the division of the shear heated material into equal portions at a downstream split.

When an equalized bulk temperature criterion is not important, then a conventional flow bore geometry where two or more axes intersect at a single point can be employed for ease of design and manufacture. The present invention improves the intersection geometry of the conventional hot runner to overcome the flow asymmetries created in the flow without adding features to the hot runner that add significant complexity and cost to a manifold system. Such added features include flow diverters, flow rotation devices located in one or more flow channels, runner segments having a substantially circular diameter that lead to a spiraling non-circular beginning portions of a subsequent runner, or other features that reposition the asymmetric thermal conditions of the flow in a circumferential direction around the center of the path of the runner.

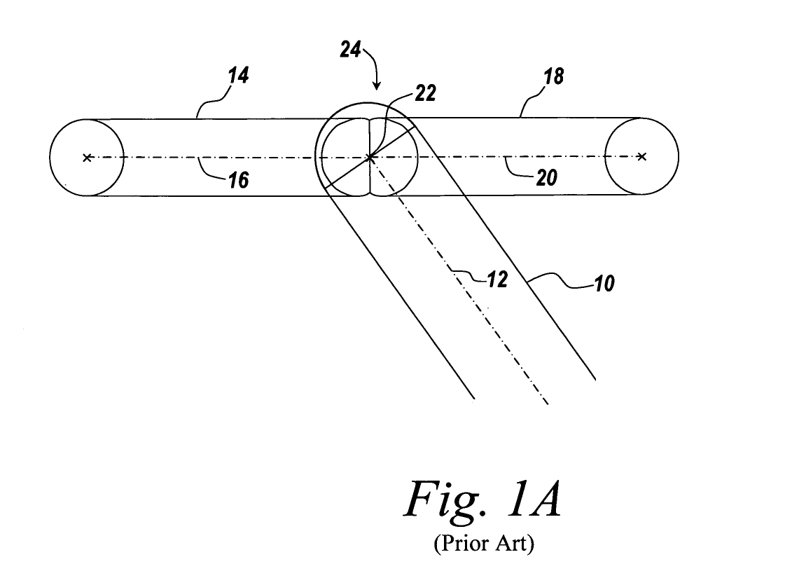

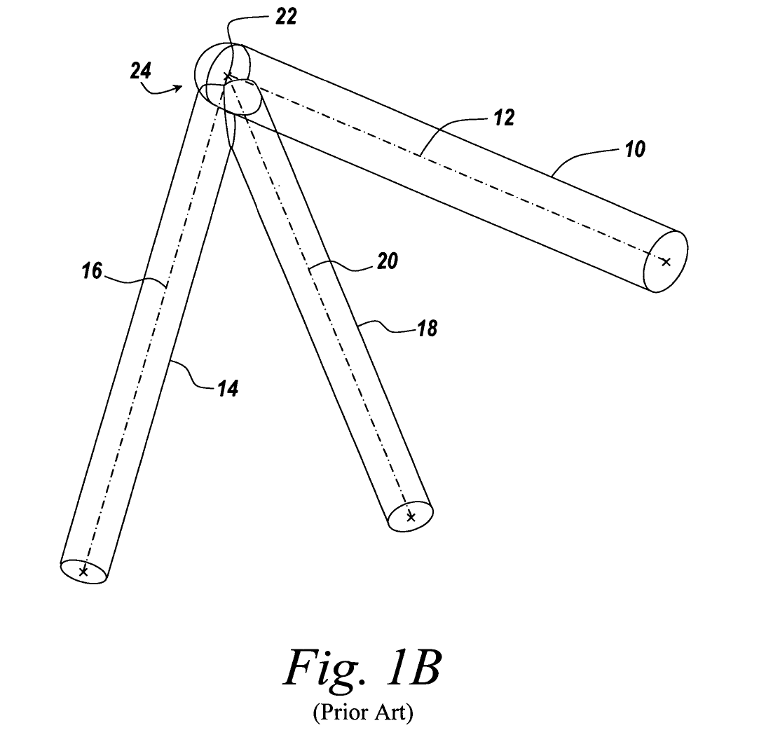

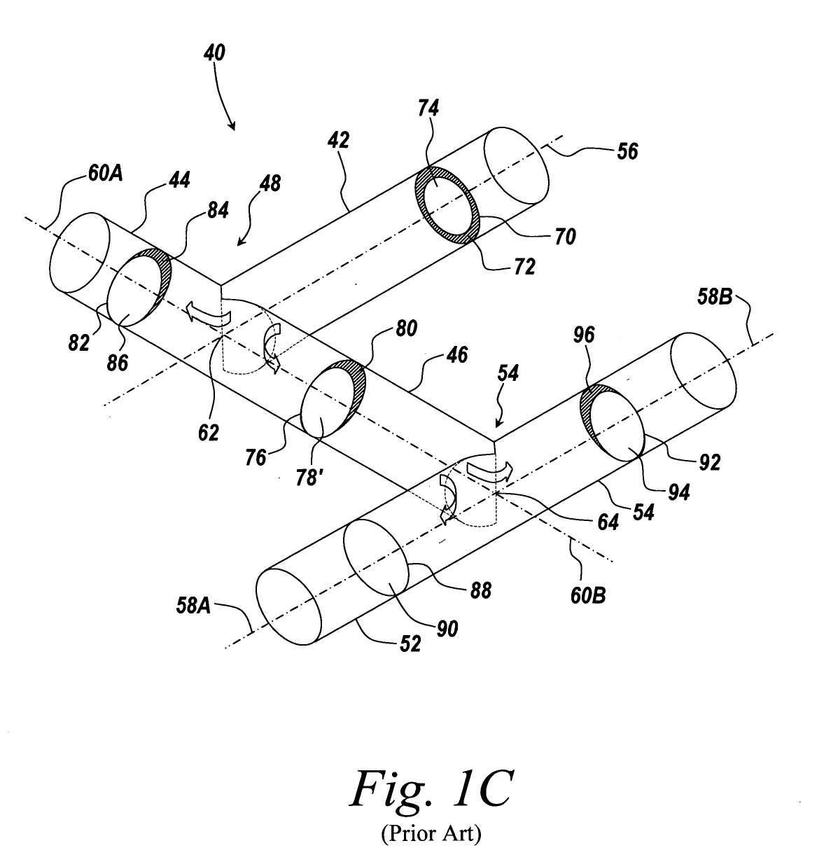

FIGS. 1A and 1B illustrate the geometry of conventional flow bore intersections of a hot runner. Notice that with the conventional geometry a central longitudinal axis of each flow bore intersects at a single point. In particular, FIGS. 1A and 1B illustrate that with the conventional hot runner intersection geometry a central longitudinal axis 12 of a first runner 10, a central longitudinal axis 14 of a second runner 14, and a central longitudinal axis 20 of a third runner 18 intersect at a common point 22 at the intersection 24. Those skilled in the art will recognize that the first runner 10 is also known as a bore. Likewise, those skilled in the art will recognize that the second runner 14 and the third runner 18 are known to as sub-bores. FIG. 1A illustrates a top view of a conventional two way flow split where the central longitudinal axis of each runner forming the flow split intersect at the common point 22. FIG. 1B illustrates an isometric view of the conventional two way flow split of FIG. 1A.

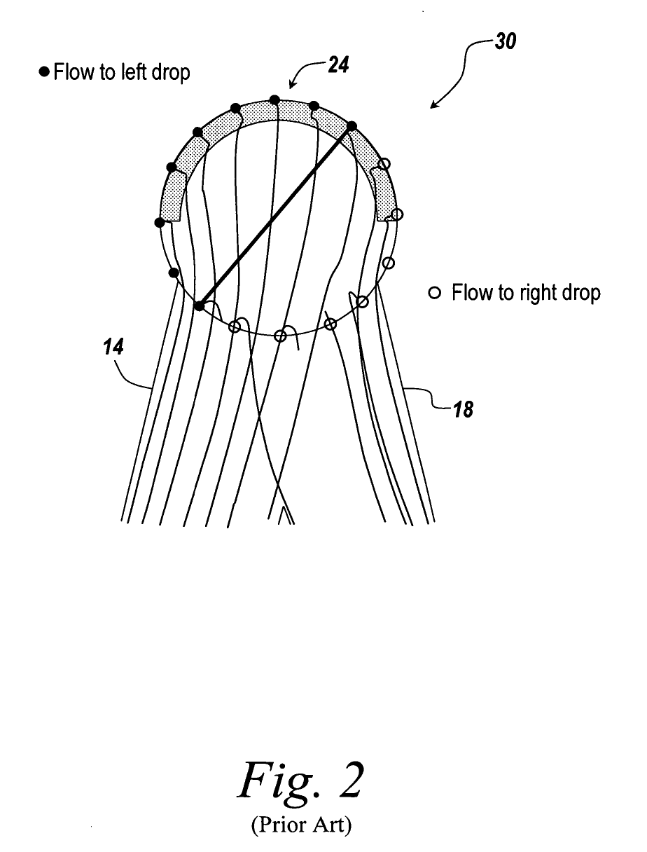

When the conventional two way flow split of FIGS. 1A and 1B are analyzed, a flow map can be created illustrating how the molten polymer material flowing downstream in the first runner 10 divides and enters the second runner 14 and the third runner 18. FIG. 2 illustrates such a flow map. The flow map 30 illustrates a view looking downstream of the first runner 10 at the intersection 24. The traces extending in a downward direction from close to the inner passage perimeter of the first runner 10 into the second runner 14 and the third runner 18 are streamlines that represent the flow of shear heated material located in an upper portion of the inner passage of the first runner 10. Those skilled in the art will appreciate that there can be multiple shear heated materials in multiple locations around the inner perimeter of a runner and the exemplary illustrations of FIGS. 1A and 1B are merely meant to facilitate understanding of the problem presented by shear heated material flowing in conventional hot runners.

Those skilled in the art will appreciate that the shear heated material has an elevated temperature due to the shear heating that occurs as the material flows in close proximity to and contacts the interior wall of the first runner 10. The closed and open circles represent the division of the shear heated material in intersection 24 between the second runner 14 and the third runner 18. The distribution or division of the shear heated material into the second runner 14 and the third runner 18 is determinable by following each streamline from its start along the inner passage perimeter of the first runner 10 into the second runner 14 and the third runner 18. The flow map 30 illustrates that the majority of the shear heated material flows into the second runner 14. The shear heated material flowing into the second runner 14 is less viscous than the cooler material flowing into the third runner 18 creating an unwanted and undesirable asymmetry between the flow in the second runner 14 and the third runner 18.

By moving away from the conventional flow bore intersection geometry of intersecting central longitudinal axes, the flow bore intersection geometry of the present invention equally distributes the shear-heated material to the sub bores and therefore equalizes their bulk temperature.

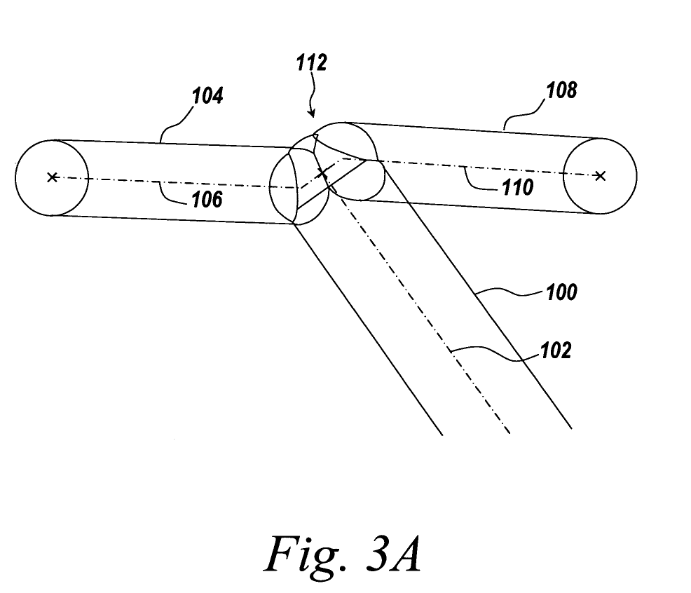

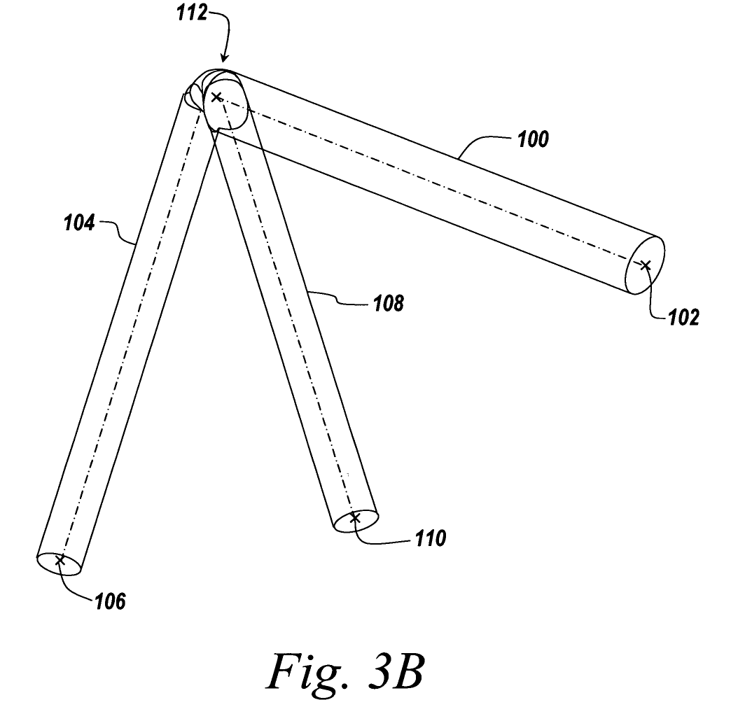

FIGS. 3A and 3B illustrate the intersection geometry of a two way split in accordance with the teachings of the present invention. The intersection 112 is formed by a first bore 100, a second bore 104, and a third bore 108. The intersection 112 has a geometry free of a common point where central longitudinal axis 102 of the first bore 100, central longitudinal axis 106 of the second bore 104, and central longitudinal axis 110 of the third bore 108 intersect. That is, the central longitudinal axis 102 of first bore 100, the central longitudinal axis 106 of second bore 104, and the central longitudinal axis 110 of third bore 108 are offset from each other so that none of the central longitudinal axes intersect in intersection 112. According to another practice, one or more of the bores can be offset relative to the remaining bores so that the longitudinal central axes of all the bores do not meet or intersect at a common point.

Moreover, the geometry and architecture depicted in FIGS. 3A and 3B accomplishes the balancing and distribution of one or more properties of a working material through a network of distribution elements without the need for an element, positioner, repositioner, or member in communication with one or more of the distribution elements to balance and distribute a thermal property of the working material through the network. Furthermore, the balancing and distribution of one or more properties of the working material through the network of distribution elements occurs where the elements intersect, which, in turn, eases the manufacture of such a distribution means.

FIG. 1C illustrates a conventional “T” like geometry of a conventional hot runner 40 where a main runner of the “T” feeds two smaller runners, and at least one of the runners feeds a subsequent split in the hot runner 40 having a “T” like geometry. The hot runner 40 includes a first runner 42 having a central longitudinal axis 56. The first runner 42 branches in two directions into a second runner 44 having a central longitudinal axis 60A and into a third runner 46 having a central longitudinal axis 60B. The intersection 48, where the first runner 42 branches into the second runner 44 and the third runner 46, has an intersect point 62 where the central longitudinal axis (56, 60A and 60B) of each respective runner intersect. In this manner, a laminar flow 70, with high shear material 72 forming a ring around the inner passage and low shear material 74 forming a center portion of the flow, of the first runner 42 flows into the intersection 48 and then further flows into the second runner 44 and the third runner 46. The high and low sheared material on the left side of the first runner 42 flows into the second runner 44 while the high and low shear material on the right side of the first runner 42 flows into the second runner 46. The high and low shear material flowing from the first runner 42 into the second runner 44 will distribute itself to form a flow 82. The material flow 70 flowing from the first runner 42 into the second runner 46 redistributes itself to form a flow 76. Flows 76 and 82 illustrate that the high shear material of flow 70 remains on the side of the second runner 44 and the third runner 46 closest to the first runner 42 while the low shear material of flow 70 redistributes itself to the side of the second runner 44 and the third runner 46 farthest away from the first runner 42. In flow 82, region 86 represents the low shear material and region 84 represents the high shear material. In similar fashion, in flow 76, region 78 represents the low shear material and region 80 represents the high shear material.

The third runner 46 forms an intersection 55 with the fourth runner 52 and the fifth runner 54. The fourth runner 52 has a central longitudinal axis 58A and the fifth runner 54 has a central longitudinal axis 58B. Intersection 55 like intersection 48 includes a common intersect point where the longitudinal axis of each runner intersects to form the intersection 55. At intersection 55, longitudinal axis 58A, longitudinal axis 60B, and longitudinal axis 58B intersect at point 64. Because of this intersection geometry, when flow 76 enters intersection 55 the flow splits and redistributes itself between the fourth runner 52 and the fifth runner 54. The flow redistribution at intersection 55 creates a flow 88 having all low sheared material as represented by region 90. The flow redistribution at intersection 55 also creates a flow 92 in the fifth runner 54. Flow 92 receives all of the high sheared material from flow 76 as represented by region 96. Flow 92 also includes low sheared material from flow 76 as represented by region 94.

FIG. 1C illustrates the unbalanced conditions that develop in a conventional hot runner system where each central longitudinal axis of each runner forming the hot runner system intersect at a common intersect point at each intersection between a runner and a downstream runner. As a result of these conditions provided by the conventional intersection geometry, flows in downstream runners become unbalanced with respect to thermal properties. This causes a number of cosmetic, quality, reliability, mechanical and other non-conformities to be formed in cavities associated with the downstream runners of a hot runner system.

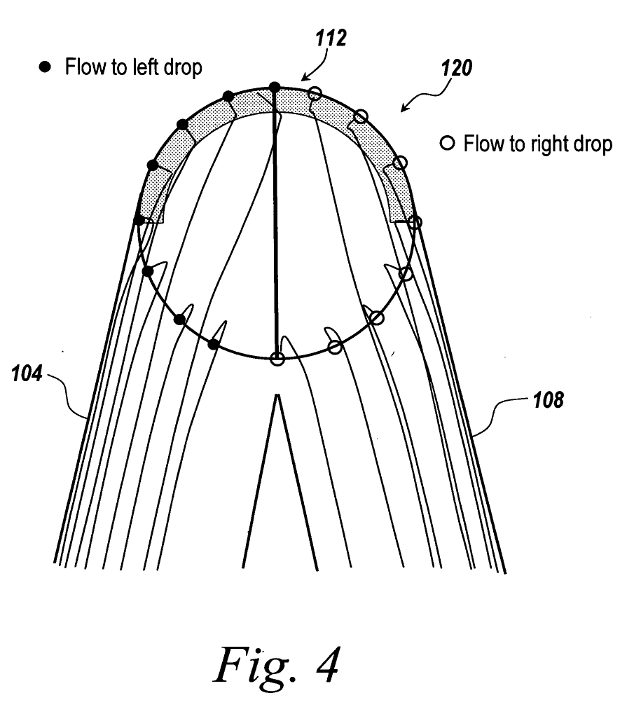

FIG. 4 illustrates a flow map 120 for the improved bore intersection geometry of the present invention. From FIG. 4 it is illustrated that half of the shear heated material located in the upper portion of the first bore 100 flows downstream into the second bore 104 and half of the shear heated material located in the upper portion of the first bore 100 flows downstream into the third bore 108 at the intersection 112. In this manner, the shear heated material from the first bore 100 is distributed between the second bore 104 and the third bore 108 in a substantially balanced fashion. That is, the flow bore intersection geometry of the present invention equally distributes the shear heated hot material amongst each sub-bore at the intersection of a bore and two or more sub-bores. Using this geometry and architecture, additional intersections are possible after each sub-bore. Each additional intersection partitions the shear heated hot material so it flows in substantially equal portions into each additional sub-bore. As such, the geometry of the intersecting elements further equalizes the pressure drop and flow rate on each of the sub bores while maintaining the path length. This results in a hot runner architecture that provides a number of significant benefits to a system or apparatus that distributes a working material from a working material source to a processing element, such as a mold cavity, a nozzle assembly, a gate assembly, and the like. As such, a hot runner having at least one intersection between a bore and two or more sub-bores where the central longitudinal axis of the bore and each sub-bore are offset to avoid intersecting in the intersection facilitates the bulk temperature distribution in at least a portion of the hot runner.

A significant advantage of the present invention is a reduction in cavity to cavity variability of a plastic goods forming process. The reduction in the variability is realized due to a number of working material flows having uniform properties flowing through and into various system elements of the plastic goods forming process. This is achieved by the non-intersecting axis arrangement of the present invention. Consequently, the reduction in cavity to cavity variability results in an increase in manufacturing throughput, an increase in product quality and reliability, and a reduction in manufacturing costs in the art of forming goods with plastic.

Another significant advantage of the hot runner architecture of the present invention is that it does not significantly increase the complexity of the manufacturing process of the hot runner or the cost of a hot runner in most instances. For example, it is not required that each bore, sub-bore, distribution element or distribution member forming a fluid carrying passage of a hot runner to have a number of radial portions placed between end portions of the fluid carrying passage to transition a flow of molten material from a first plane to at least a second plane to shift a thermal property of the flow before the flow reaches an intersection with another fluid carrying passage. As a result, the distribution members and elements forming an illustrative hot runner of the present invention can have a substantially straight path from a first end portion to a second end portion and shift or balance a thermal property of the working material at an intersection where distribution members interconnect.

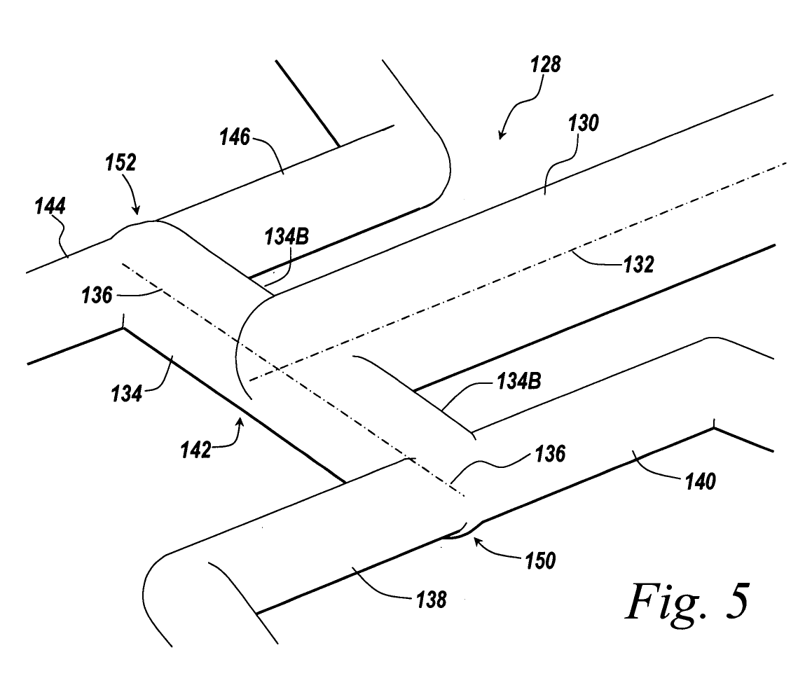

FIG. 5 illustrates another exemplary two-way split in a distribution means having an intersection geometry and architecture in accordance with the present invention. The illustrated hot runner 128 has a first runner 130, a second runner 134, a third runner 138, a fourth runner 140, a fifth runner 144, and a sixth runner 146. The first runner 130 has an inner passage for carrying a working material flow in an axial direction along central longitudinal axis 132. The second runner 134 has an inner passage for carrying a working material flow in an axial direction along central longitudinal axis 136. Those skilled in the art will recognize that second runner 134 is considered a branching runner that branches in two directions and can therefore have a first branch 134A and a second branch 134B. Likewise, third runner 138, fourth runner 140, fifth runner 144, and sixth runner 146 each have an inner passage for carrying the working material flow in an axial direction along a central longitudinal axis for at least a portion of each runner.

The first runner 130 orthogonally intersects second runner 134 to form intersection 142. At intersection 142, the central longitudinal axis 132 of first runner 130 is out of plane with the central longitudinal axis 136 of the second runner 134. In this manner, intersection 142 has an intersection geometry where at least two central longitudinal axes of at least two runners forming the intersection do not intersect at a common point.

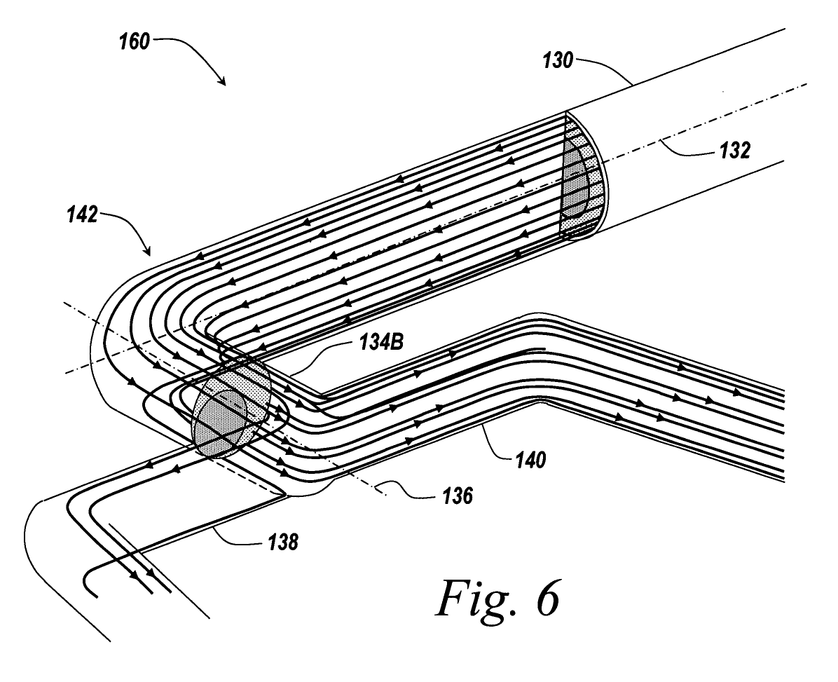

FIG. 6 depicts an exemplary flow map 160 for the hot runner 128. From FIG. 6 it is illustrated that half of the working material located in the outer half of the first runner 130 flows downstream into second branch 134B. In turn, a significant portion of the working material flowing in branch 134B flows downstream into a fourth runner 140 while a smaller portion of the working material flowing in the branch 134B flows into third runner 138. That is, intersection 142 equally divides the working material flowing downstream in first runner 130 to direct 50% of that flow into second branch 134B of second runner 134 towards third runner 138 and fourth runner 140. Likewise, intersection 142 directs 50% of the working material flow (not shown) from first runner 130 into the first portion 134A of second runner 134 towards fifth runner 144 and sixth runner 146.

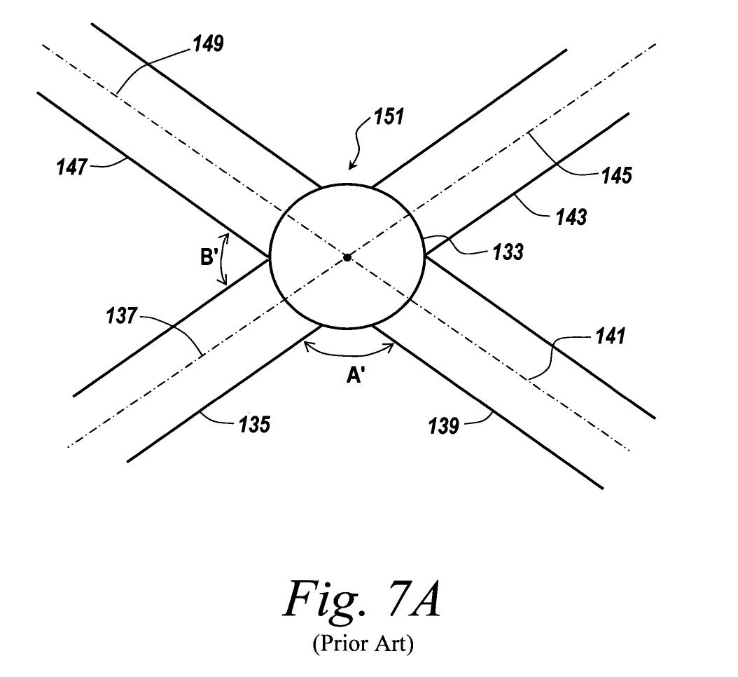

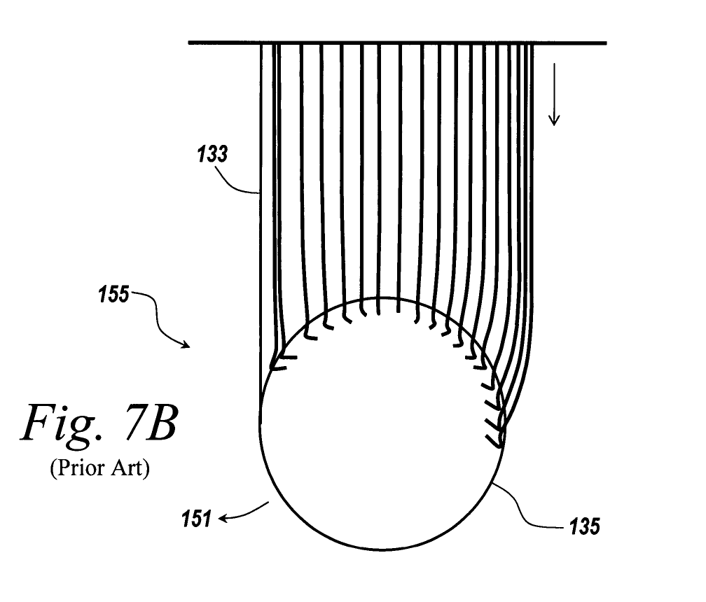

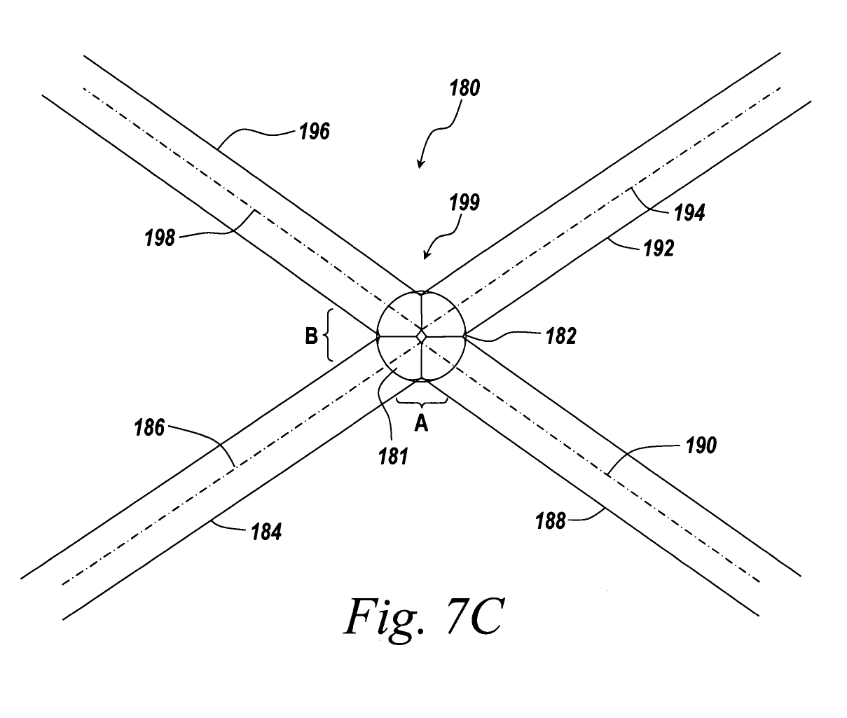

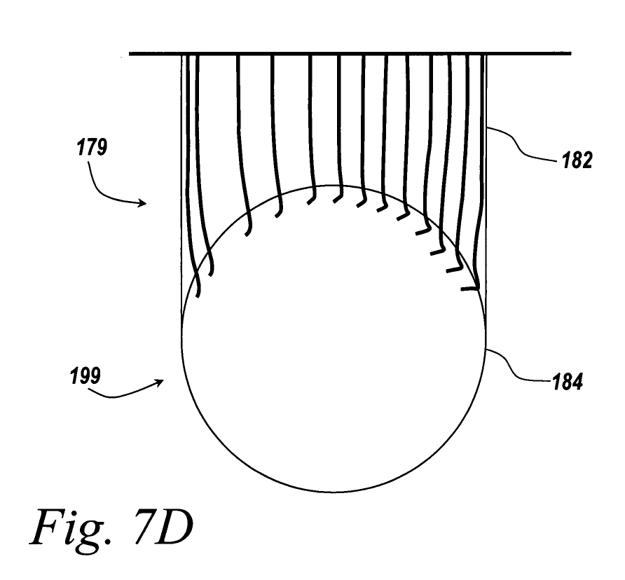

FIG. 7A depicts the prior art of a four-way split configuration of a hot runner 131 having an intersection geometry where each longitudinal axis of each runner intersects at a common intersect point. The four-way split hot runner 131 includes a first runner 135, a second runner 139, a third runner 143, and a fourth runner 147. The first runner 135 includes a central longitudinal axis 137. The second runner 139 includes a central longitudinal axis 141. Likewise, the third runner 143 includes a central longitudinal axis 145 and the fourth runner 147 includes a central longitudinal axis 149. An intersection 151 formed by a vertical runner 133, the first runner 135, the second runner 139, the third runner 143, and the fourth runner 147 includes a common intersect point 153 where each longitudinal axis (137, 141, 145, and 149) intersect. In the four-way split hot runner 131, an obtuse angle (A′) is formed between the outer wall of the first runner 135 and the outer wall of the second runner 139. Additionally, an acute angle (B′) is formed between the outer wall portion of the first runner 135 and the outer wall portion of the fourth runner 147.

FIG. 7B depicts an exemplary flow map of shear heated material flowing downstream from a vertical runner 133 into one of the four runners forming the four-way split hot runner 131. For purposes of illustrating a flow distribution of the shear heated material flowing along the inner perimeter of the vertical runner 133 at intersection 151, the description of the flow map 155 in FIG. 7B is taken from the perspective of looking in a downstream direction of the vertical runner 135 from intersection 151. Flow map 155 depicts that the shear heated material distribution at intersection 151 exhibits a clockwise rotation of the flow distribution into the first runner 135, which is considered an asymmetric distribution. As such, a portion of the shear heated material flows into the first runner 135 below a horizontal centerline of the inner passage along the longitudinal axis 137. The asymmetric shear heated flow distribution in the first runner 135 becomes more asymmetric at a subsequent intersection, for example, a “T” like intersection. At a subsequent “T” like intersection, a majority of the shear heated material from the first runner 135 is distributed into the right branch of the “T” like intersection while the left branch of the “T” like intersection receives an unequal distribution of the shear heated material.

FIG. 7C illustrates an exemplary “X” like split configuration of a hot runner 180 in accordance with the present invention. The hot runner 180 includes a vertical runner 181 intersecting a first runner 184, a second runner 188, a third runner 192, and a fourth runner 196 to form an intersection 199. The first runner 184 includes a central longitudinal axis 186, and, likewise, the second runner 188 includes a central longitudinal axis 190. In similar fashion, the third runner 192 includes a central longitudinal axis 194, and the fourth runner 196 includes a central longitudinal axis 198. The intersection 199 includes a geometry that avoids having each central longitudinal axis of each runner intersect at a common point at the intersection 199. The first runner 184, the second runner 188, the third runner 192, and the fourth runner 196 intersect at an obtuse angle (A) between an outer wall of the first runner 184 and an outer wall of the second runner 188. Likewise, the intersection of the first runner 184, the second runner 188, the third runner 192 and the fourth runner 196 form an acute angle (B) between an outer wall of the first runner 184 and an outer wall of the fourth runner 196.

FIG. 7D depicts an exemplary flow map 179 illustrating the distribution of the shear heated material that occurs at the intersection 199 of the “X” like split hot runner 180 illustrated in FIG. 7C. The flow map 179 depicts the shear heated material distribution flowing around the inner perimeter of the vertical runner 182 into the first runner 184 at the intersection 199. The perspective of the flow map 179 is taken from the intersection 199 looking downstream into the first runner 184. The flow map 179 illustrates that the geometry of the intersection 199 avoids the clockwise or counter-clockwise rotation of shear heated material from the vertical runner 182 into one of the four runners forming the “X” like split hot runner 180. As such, the shear heated material flowing from the vertical runner 182 into the first runner 184 remains above a horizontal centerline of the first runner 184 along the central longitudinal axis 186. The geometry of the intersection 199 provides a beneficial flow distribution by positioning the shear heated material substantially across the top portion of the first runner 184 to facilitate distribution at a downstream branch of the first runner 184.

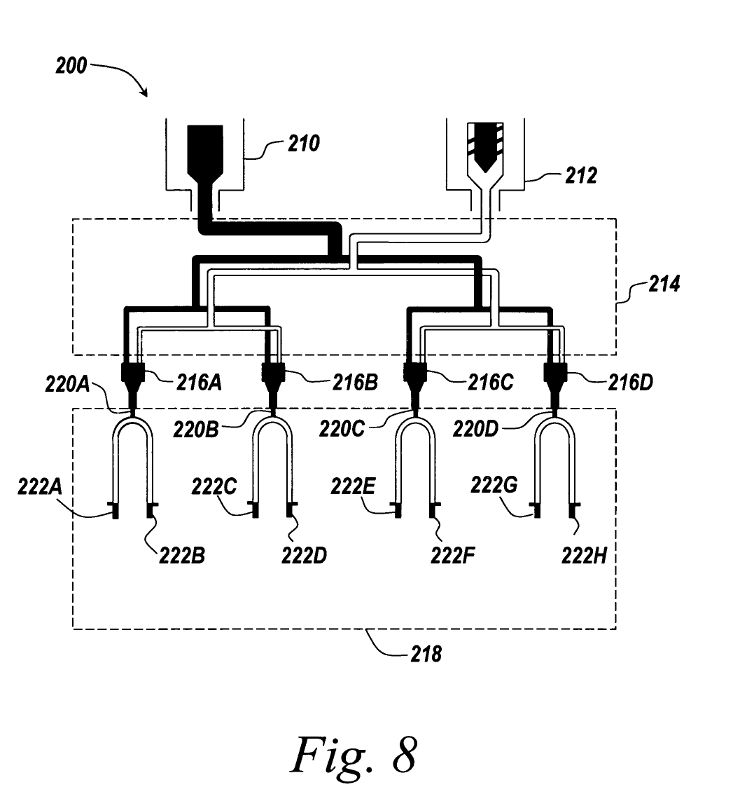

FIG. 8 illustrates an exemplary system suitable for practicing the present invention. The illustrated co-injection molding system 200 is configured to inject at least two materials into a mold cavity. Working materials suitable for use with the present invention include polymer based materials such as, polyethylene terephthalate (PET), ethylene vinyl alcohol (EVOH), polycarbonates and the like. Co-injection molding system 200 includes a first working material source 210, a second working material source 212, and a distribution means 214. Co-injection molding system 200 further includes nozzle assemblies 216A-216D and mold 218. Mold 218 includes gates 220A-220D and cavities 222A-222H.

For the purposes of the discussion herein, the use of the term “distribution means” refers to a plurality of interconnected fluid carrying passages for distributing at least one fluid flow received from an inlet to one or more egresses. A distribution means can include a number of sets of manifold blocks or a number of sets of fluid carrying passages. Known terms of art such as hot runner and manifold are a distribution means.

In operation, first working material source 210, second working material source 212, and distribution network 214 cooperatively operate to deliver at least two working material streams to nozzle assemblies 216A-216D upstream of gates 220A-220D. Nozzle assemblies 216A-216D combine the working material streams and feed gates 220A-220D with a combined material stream for delivery to cavities 222A-222H.

In one embodiment of the present invention, first and second working material sources 210 and 212 are reciprocating screw injection units and distribution means 214 is a hot runner having separate flow channels for each working material and being arranged such that the material flow through each flow channel is balanced and equal.

Distribution network 214 includes at least one intersection between a bore and a sub-bore having an intersection geometry and architecture in accordance with the present invention. In this manner, distribution network 214 can distribute one or more properties of a working material to facilitate the division of the working material in a downstream location of the distribution network 214 without the need for an element, positioner, repositioner, or member in communication with one or more of the distribution elements to balance and distribute a thermal property of the working material through each of the networks. Furthermore, distribution of one or more properties of the working material through the network of distribution elements forming distribution network 214 occurs where the elements intersect, which, in turn, eases the manufacture of such a distribution means.

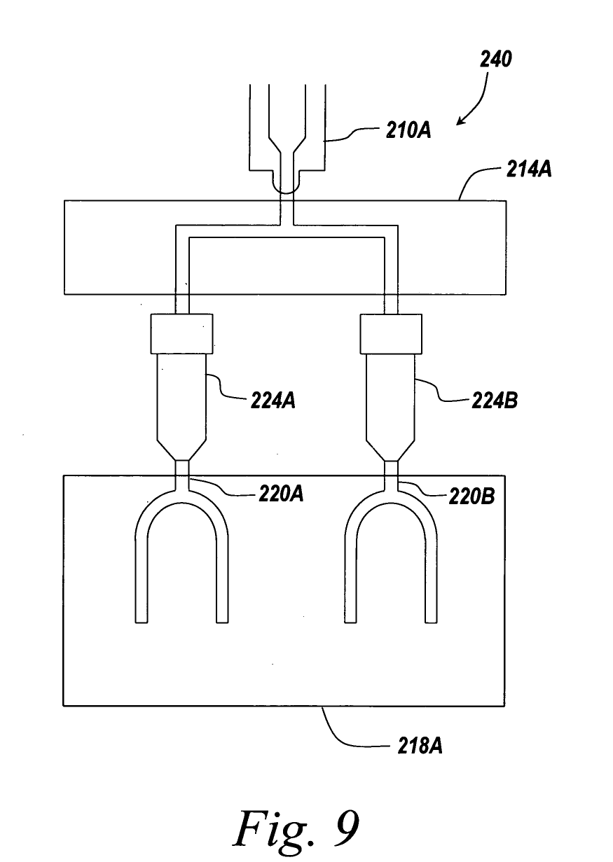

FIG. 9 illustrates an exemplary system suitable for practicing the present invention. Injection molding system 240 is configured to inject one working material into a mold cavity. Working materials suitable for use with the present invention include polymer based materials such as, polyethylene terephthalate (PET), ethylene vinyl alcohol (EVOH), polycarbonates and the like. Injection molding system 240 includes a working material source 210A and a distribution network 214A. Injection molding system 240 further includes nozzle assemblies 224A, 224B, and mold 218. Mold 218 includes gate 220A, gate 220D, cavity 222A, and cavity 222B.

In operation, working material source 210A and distribution means 214A cooperatively operate to deliver a working material stream to nozzle assemblies 224A and 224B upstream of gates 220A and 220B. Nozzle assemblies 224A and 224B feed gates 220A and 220B with a working material stream for delivery to cavities 222A and 222B.

Distribution network 214A includes at least one intersection between a bore and a sub-bore having an intersection geometry and architecture in accordance with the present invention. In this-manner, distribution network 214A can distribute one or more properties of a working material to facilitate the division of the working material in a downstream location of the distribution network 214A without the need for an element, positioner, repositioner, or member in communication with one or more of the distribution elements to balance and distribute a thermal property of the working material through each of the networks. Furthermore, distribution of one or more properties of the working material through the network of distribution elements forming distribution network 214 occurs where the elements intersect, which, in turn, eases the manufacture of such a distribution means.

Although a number of splits are illustrated, those skilled in the art will recognize and appreciate that the geometry and architecture of an intersection in a distribution network provided by the present invention is well suited for use with more than, two, three, four, and five intersecting elements, for example, six, seven or more intersecting distribution elements, members or flow bore passages. In this manner, the distribution members of the present invention are capable of forming one or more distribution networks to distribute at least a pressure flow value and a shear-heating thermal property, along with other material properties of a working material through the distribution network to form a number of working material streams having a number of like properties. As a result, one or more hot runners are capable of being formed to feed a processing means, such as a mold, one or more nozzles, or one or more gates associated with the hot runner with multiple streams of a working material that have a substantially equal flow rate and shear heating thermal property.

The geometry and architecture of the distribution elements and an intersection where the elements intersect within a distribution means provides a significant advantage when the working material exhibits a non-Newtonian flow, such as by a molten polymer material. The geometry and architecture of the distribution elements and the intersection where they intersect addresses the relationship of viscosity and material temperature of the material flow to balance at least one of these properties at each intersection where two or more distribution elements within a hot runner intersect. The geometry and architecture of the distribution elements and the intersection where the elements intersect provides a further benefit to co-injection systems that simultaneously inject more than one polymer-based working material, because such a geometry and architecture provides a substantially equal pressure drop and heat history through a multitude of distribution elements from a working material source to each gate, nozzle assembly or mold cavity of the system while maintaining a simultaneous or near simultaneous flow of the two or more polymer-based working materials through various portions of the co-injection system.

While the present invention has been described with reference to the above illustrative embodiments, those skilled in the art will appreciate that various changes in form and detail may be made without departing from the intended scope of the present invention as defined in the appended claims.

What is claimed:

1. A system to produce a molded object, the system comprising:
a mold for molding the object; and
a distribution network to distribute a working material from a working material source to the mold to produce the molded object, the distribution network having at least one intersection formed between an end portion of an upstream bore having a central longitudinal axis and a portion of a downstream bore having a central longitudinal axis,
wherein the central longitudinal axis of the of the upstream bore and the downstream bore are non-intersecting and the distribution network distributes a thermal property of the working material and a pressure value of the working material through each portion of the distribution network to provide the mold with a plurality of working material flows having a substantially uniform pressure drop, a substantially uniform flow rate, and a substantially uniform thermal property.

2. The system of claim 1, wherein the portion of the downstream bore forming the intersection comprises an end portion.

3. The system of claim 1, wherein the portion of the downstream bore forming the intersection comprises a mid point portion located substantially equally between a first end portion and a second end portion.

4. The system of claim 1, wherein the central longitudinal axis of the upstream bore is out of plane with the central longitudinal axis of the downstream bore.

5. The system of claim 1, wherein the working material comprises a material exhibiting a non-Newtonian flow.

6. The system of claim 4, wherein the material comprises a plastic.

7. The system of claim 1, wherein the thermal property comprises a shear heating effect of the working material.

8. The system of claim 1, wherein the thermal property comprises a heat history of the working material.

9. The system of claim 1, wherein the system comprises a co-injection system capable of simultaneously injecting two or more working materials into the mold.

10. The system of claim 1, wherein the system comprises an injection system capable of injecting a working material into the mold.

11. An assembly for distributing a molten working material from a material source to a processing means having at least one input to receive the molten working material, the assembly comprising:
an input to receive the molten working material from the material source; and
a plurality of fluid passages in communication with the input of the assembly and with the at least one input of the processing means,
wherein two of the plurality of fluid passages intersect at a location in the assembly to form an intersection free of a point where a central longitudinal axis of each of the two fluid passages intersect, the plurality of fluid passages being adapted to control distribution of a thermal property and a pressure value of the molten working material through the plurality of passages to feed each of the plurality of inputs of the processing means with a plurality of working material streams having a like pressure value and a like thermal property.

12. The assembly of claim 11, wherein the two fluid passages intersect to form a “T” like intersection, wherein the central longitudinal axes of the two fluid passages in the “T” like intersection are out of plane with respect to each other.

13. The assembly of claim 11, wherein the processing means comprises at least one of a mold, a gate assembly and a nozzle assembly.

14. The assembly of claim 11, wherein the working material source comprises a first working material source providing the assembly with a first molten working material and a second working material source providing the assembly with a second molten working material.

15. A method for manufacturing a distribution network having an input to receive a molten material, a plurality of outputs to output the molten material and a network of distribution members in communication with the input and the plurality of outputs for apportioning a thermal property of the molten matter into substantially equal portions along each distribution member and at each of the plurality of outputs, each of the distribution members having an inner passage and a longitudinal axis, the method comprising the steps of,
providing a workpiece for manufacturing the distribution network;
forming the input of the distribution network in the workpiece;
forming the plurality of outputs of the distribution network in the workpiece;
machining one or more of the distribution members at an angle offset from the normal of a horizontal axis of the workpiece to form a portion of the distribution network, the portion having an intersection formed by at least two distribution members, wherein at the least two distribution members each have a central longitudinal axis and each of the central longitudinal axes are skewed with respect to each other.

16. The method of claim 15 further comprising the step of machining one or more of the distribution members at an angle offset from the normal of a vertical axis of the workpiece.

17. A method for distributing a molten working material from a working material source to a processing element, the molten working material having at least two thermal properties, the method comprising the steps of,
receiving the molten working material at an input of a manifold having a plurality of branch points for dividing the molten working material into a plurality of output streams for delivery to the processing element; and
distributing the working material at one of the branch points where a central longitudinal axis of a bore feeding the branch point with the molten material is offset from a central longitudinal axis of at least one sub-bore of the branch point to cause each of the plurality of output streams to have a substantially similar thermal property at a substantially similar flow rate.

18. The method of claim 17, wherein the step of distributing further includes the step of,
receiving, at each branch point a flow rate of the working material; and
dividing at each branch point, a flow rate and a thermal property of the working material in a desired ratio to distribute the working material in the desired ration amongst a plurality of outlets of the branch point.

19. A distribution network for distributing a molten working material from a working material source to a mold having at least one input to receive the molten working material, the distribution network comprising:
a first flow channel having an inner passage and a central longitudinal axis,
a second flow channel having an inner passage and a central longitudinal axis, and
an intersection formed by a portion of the first flow channel and a portion of the second flow channel, wherein in the intersection the central longitudinal axis of the first and second flow channels are non-intersecting.

20. The distribution network of claim 19, wherein the intersection distributes a thermal property of the working material flowing through the first flow channel into the intersection between the first and second flow channels to form two material streams of the working material in the second flow channel having substantially similar thermal properties.
